(19) United States
(12) Patent Application Publication
(10) Pub. No.: US 2024/0212634 A1
(43) Pub. Date: Jun. 27, 2024

(54) CUTOFF PREDICTION FOR HISTOGRAM DATA AND BACKLIGHT CONTROL

(71) Applicant: QUALCOMM Incorporated, San Diego, CA (US)

(72) Inventors: Sarath Babu NARENDRAN, Bangalore (IN); Kashish WATTAL, Ghaziabad (IN); Abhishek DE, Bangalore (IN); Panikumar Gururaj KALLAMBALLE, Bengaluru (IN)

(21) Appl. No.: 18/069,925

(22) Filed: Dec. 21, 2022

(51) Int. Cl. G09G 3/34; G09G 3/20

(52) U.S. Cl. CPC G09G 3/3406; G09G 3/2007; G09G 3/2096; G09G 2320/0626; G09G 2360/16

(57) ABSTRACT

Aspects presented herein relate to methods and devices for display processing including an apparatus, e.g., a CPU. The apparatus may obtain a first indication of an initial histogram for a current frame. The apparatus may also calculate a normalized histogram for the current frame based on a brightness level of the current frame and a total number of pixels in the current frame. Further, the apparatus may select a set of pixel intensity values from a plurality of pixel intensity values for the current frame. The apparatus may also calculate an updated brightness cutoff threshold based on the set of pixel intensity values for the current frame and a set of parameters for a pixel intensity distribution of the current frame. The apparatus may also transmit a second indication of a mapping of the updated brightness cutoff threshold to a backlight value of the current frame.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a central processing unit (CPU), a display processing unit (DPU), a graphics processing unit (GPU), or any apparatus that may perform display processing. The apparatus may obtain a first indication of an initial histogram for a current frame in a set of frames, where the initial histogram for the current frame is associated with a brightness level of the current frame, where the initial histogram includes a brightness cutoff threshold for the brightness level of the current frame. The apparatus may also read data corresponding to the initial histogram for the current frame, where the data is associated with the brightness level of the current frame. Additionally, the apparatus may identify the brightness cutoff threshold of the initial histogram for the current frame based on the first indication of the initial histogram for the current frame. The apparatus may also calculate a normalized histogram for the current frame based on the brightness level of the current frame and a total number of pixels in the current frame. Moreover, the apparatus may calculate a normalized cumulative histogram for the current frame based on the normalized histogram. The apparatus may also select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels. The apparatus may also estimate a set of parameters for a pixel intensity distribution of the current frame based on the set of pixel intensity values for the current frame, where an updated brightness cutoff threshold is calculated based on the set of pixel intensity values and the estimated set of parameters. Further, the apparatus may calculate an updated brightness cutoff threshold based on the set of pixel intensity values for the current frame and a set of parameters for a pixel intensity distribution of the current frame. The apparatus may also map the updated brightness cutoff threshold to the backlight value of the current frame prior to transmitting a second indication of the mapping of the updated brightness cutoff threshold to the backlight value of the current frame. The apparatus may also transmit a second indication of a mapping of the updated brightness cutoff threshold to a backlight value of the current frame. Also, the apparatus may transmit a third indication of the backlight value of the current frame based on the mapping of the updated brightness cutoff threshold to the backlight value of the current frame.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example mask layer for display processing.

FIG. 5 is a diagram illustrating an example layer composition scheme for display processing.

FIG. 6A is a diagram illustrating an example brightness cutoff threshold.

FIG. 6B is a diagram illustrating an example brightness cutoff threshold.

FIG. 7 is a diagram illustrating an example flowchart for a brightness cutoff prediction technique.

FIG. 8 is a diagram illustrating example communication between a DPU, a CPU, and a display panel.

FIG. 9 is a graph illustrating an example cumulative distribution function (CDF).

FIG. 10 is a graph illustrating an example image histogram.

FIG. 11 is a graph illustrating example backlight values for brightness cutoff thresholds.

FIG. 12 is a communication flow diagram illustrating example communications between a CPU, a DPU, and a display.

FIG. 13 is a flowchart of an example method of display processing.

FIG. 14 is a flowchart of an example method of display processing.

### DETAILED DESCRIPTION

Some types of display processing devices (e.g., mobile devices, computers, TVs, or other consumer devices) may utilize different types of lighting techniques for the display. For instance, display processing devices may utilize different types of backlight techniques. Also, for some types of display devices, image quality and power consumption are major factors affecting the performance of the device. In some aspects, display processing devices may utilize different levels of backlight that are dependent on the type of content. That is, display processing devices may utilize content-adaptive backlight (CABL), which is a content-adaptive backlight reduction technique. Content-adaptive backlight techniques may be utilized to adjust the backlight and promote the performance of mobile devices (e.g., liquid crystal displays (LCDs)). In some instances, the goal of content-adaptive backlight techniques may be to reduce the amount of power utilized at the display. For example, content-adaptive backlight techniques may aim to reduce the backlight (e.g., light-emitting diode (LED) backlight) by boosting the pixels, so that there may not be much quality difference to the image. Additionally, content-adaptive backlight techniques may predict the backlight using a cutoff point. The cutoff point may be obtained from the histogram of a particular image or a particular frame. The cutoff may be defined as a power reduction threshold for the brightness point equal to the 90th percentile of the histogram. That is, a brightness level of 10% may be a cutoff threshold for a power reduction and corresponding reduction in backlight intensity. As such, if the brightness content varies slightly (e.g., varies between 9% and 11% brightness) there may be an abrupt and stark backlight intensity change between similar frames. This abrupt and stark backlight intensity change between similar frames may be based on the changes above and below the brightness power reduction threshold (i.e., the cutoff). Since the cutoff is based on a hard threshold value, the backlight obtained for images may be drastically different. For example, the images may result in a backlight level of 5% and 50%, respectively. For a slight difference in light content (e.g., 9% compared to 10%), a user may perceive a large backlight level fluctuation on the screen at the display device (e.g., a backlight level fluctuation of 5% and 50%). This backlight level fluctuation may be between consecutive frames, which will be perceived as an abrupt backlight level change. For instance, the user may perceive this backlight level fluctuation as a screen brightness change or error based on the stark difference in backlight levels. For example, if the brightness cutoff to reduce the power and a corresponding reduction in backlight intensity is 10%, there will be backlight intensity flickering for consecutive frames including a brightness content that varies from 9 to 11%. As indicated above, a narrow difference in dark content and bright content in subsequent frames may result in a large difference in backlight levels based on the cutoff (i.e., a power reduction threshold). That is, the cutoff or power reduction threshold may be a threshold at which the power will be reduced based on a corresponding backlight intensity reduction. Additionally, this may result in a problem when tuning algorithms for the visual quality of the display. For example, if a customer wants to tune an application to adjust the backlight levels, it may be difficult to do so because the images are so similar. Aspects of the present disclosure may avoid stark differences in backlight levels between successive frames. For instance, aspects presented herein may utilize a technique to avoid stark differences in backlight level for small variations in image content between successive frames. By doing so, aspects presented herein may avoid abrupt backlight level change in successive frames. Accordingly, aspects presented herein may reduce the likelihood that a user may perceive a backlight level fluctuation as a screen brightness change or error based on the stark difference in backlight levels in successive frames. Additionally, aspects presented herein may avoid the use of a hard cutoff threshold that corresponds to the point at which power will be reduced based on a backlight intensity reduction. That is, aspects presented herein may avoid backlight intensity flickering in consecutive frames and/or avoid abrupt changes in backlight intensity in successive frames. For example, aspects presented herein may reduce the likelihood that power reduction cutoff points affect the user perception of backlight brightness levels in consecutive frames. As such, aspects presented herein may result in an improvement in the overall visual experience for users of display devices.

Aspects of the present disclosure may include a number of benefits or advantages. For instance, aspects presented herein may avoid stark differences in backlight levels between successive frames. That is, aspects presented herein may utilize a technique to avoid stark differences in backlight level for small variations in image content between successive frames. By doing so, aspects presented herein may avoid abrupt backlight level change in successive frames. As such, aspects presented herein may reduce the likelihood that a user may perceive a backlight level fluctuation as a screen brightness change or error based on the stark difference in backlight levels in successive frames. Also, aspects presented herein may avoid the use of a hard cutoff threshold that corresponds to the point at which power will be reduced based on a backlight intensity reduction. Further, aspects presented herein may avoid backlight intensity flickering in consecutive frames and/or avoid abrupt changes in backlight intensity in successive frames. For example, aspects presented herein may reduce the likelihood that power reduction cutoff points affect the user perception of backlight brightness levels in consecutive frames. Accordingly, aspects presented herein may result in an improvement in the overall visual experience for users of display devices.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

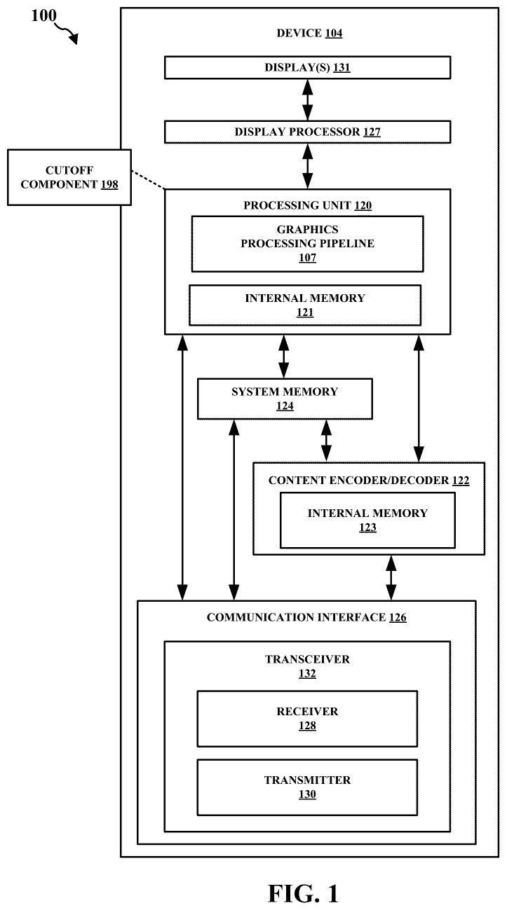

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a cutoff component 198 configured to obtain a first indication of an initial histogram for a current frame in a set of frames, where the initial histogram for the current frame is associated with a brightness level of the current frame, where the initial histogram includes a brightness cutoff threshold for the brightness level of the current frame. The cutoff component 198 may also be configured to read data corresponding to the initial histogram for the current frame, where the data is associated with the brightness level of the current frame. The cutoff component 198 may also be configured to identify the brightness cutoff threshold of the initial histogram for the current frame based on the first indication of the initial histogram for the current frame. The cutoff component 198 may also be configured to calculate a normalized histogram for the current frame based on the brightness level of the current frame and a total number of pixels in the current frame. The cutoff component 198 may also be configured to calculate a normalized cumulative histogram for the current frame based on the normalized histogram. The cutoff component 198 may also be configured to select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels. The cutoff component 198 may also be configured to estimate a set of parameters for a pixel intensity distribution of the current frame based on the set of pixel intensity values for the current frame, where an updated brightness cutoff threshold is calculated based on the set of pixel intensity values and the estimated set of parameters. The cutoff component 198 may also be configured to calculate an updated brightness cutoff threshold based on the set of pixel intensity values for the current frame and a set of parameters for a pixel intensity distribution of the current frame. The cutoff component 198 may also be configured to map the updated brightness cutoff threshold to the backlight value of the current frame prior to transmitting a second indication of the mapping of the updated brightness cutoff threshold to the backlight value of the current frame. The cutoff component 198 may also be configured to transmit a second indication of a mapping of the updated brightness cutoff threshold to a backlight value of the current frame. The cutoff component 198 may also be configured to transmit a third indication of the backlight value of the current frame based on the mapping of the updated brightness cutoff threshold to the backlight value of the current frame. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

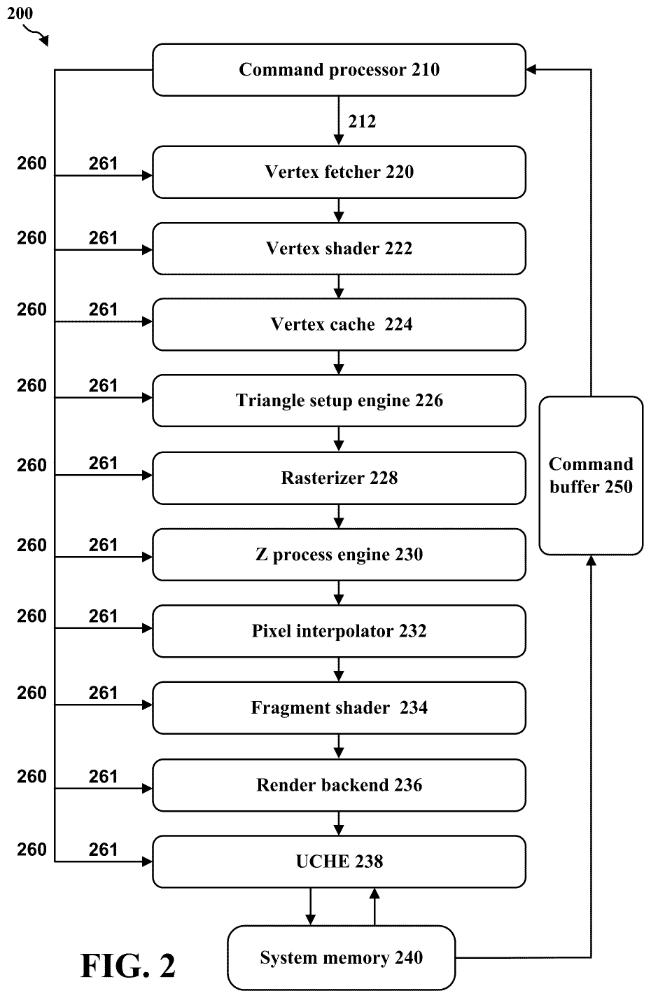

FIG. 2 illustrates an example GPU 200 in accordance with one or more techniques of this disclosure. As shown in FIG. 2, GPU 200 includes command processor (CP) 210. draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

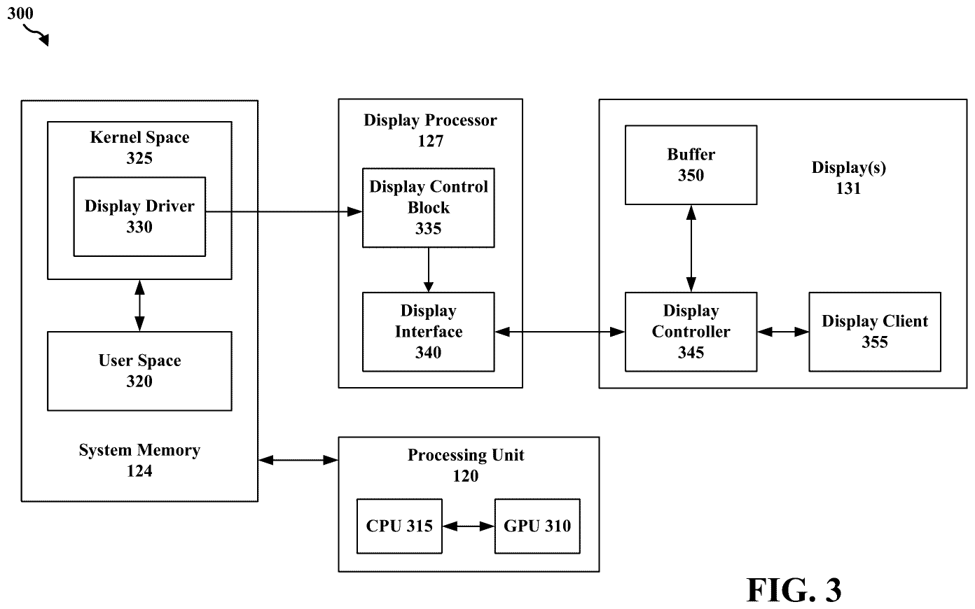

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131. one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

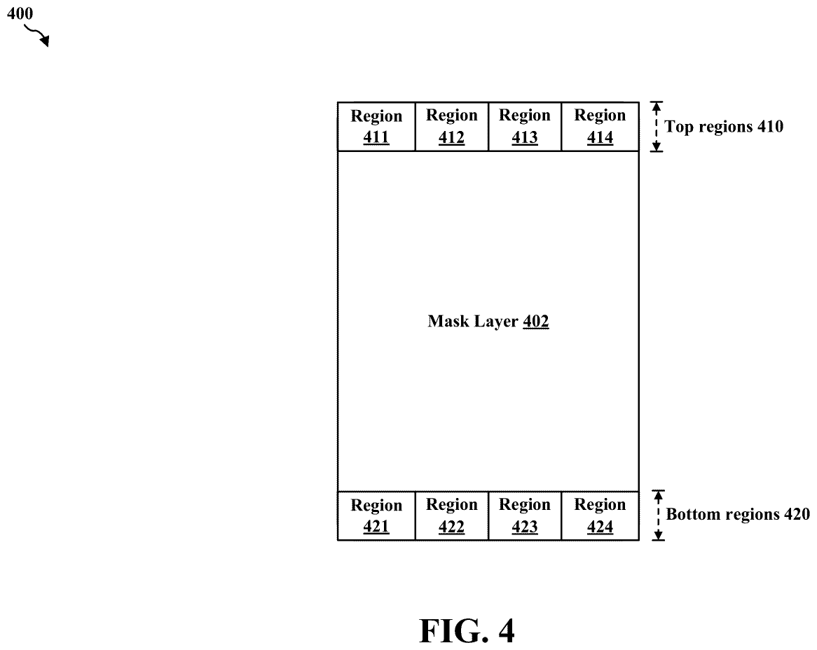

FIG. 4 is a diagram 400 illustrating an example mask layer for display processing. More specifically, diagram 400 depicts one type of mask layer that may represent portions of a display panel. As shown in FIG. 4, diagram 400 includes mask layer 402 including top regions 410 and bottom regions 420. Top regions 410 include region 411, region 412, region 413, and region 414, and bottom regions 420 include region 421, region 422, region 423, and region 424. As depicted in FIG. 4, mask layer 402 may represent the different regions that are displayed on a display panel. Some types of displays may use a certain type of mask layer (e.g., a shape mask layer) to reshape a display frame. For instance, a mask layer may reshape the display frame to provide more optimized visual shapes at the display panel (e.g., improved round corners, improved circular shape, improved rectangular shape, etc.). These types of mask layers (e.g., shape mask layers) may be processed by software (e.g., graphics processing unit (GPU) software or central processing unit (CPU) software) or by hardware (e.g., display processing unit (DPU) hardware). Also, these mask layers may be processed by other specific types of hardware logic modules (e.g., modules in a display driver integrated circuit (DDIC) or bridge chips). In some aspects, these types of mask layers (e.g., shape mask layers) may be based on certain unit, such as a pixel. That is, the shape generation basis unit of the shape mask layers may be a single pixel.

Some aspects of display processing may utilize frame buffers to cache or store a composition output of a GPU. For instance, display layers may be cached or stored in a frame buffer after composition at a GPU. In some aspects, a composition hardware (HW) or software (SW) stack may use a frame buffer target to cache a composition output (e.g., a GPU composition output or a CPU composition output). The cached composition output may then be sent to another processor (e.g., a DPU) as an input layer. The frame buffer may have a number of different color formats, such as a red (R) green (G) blue (B) alpha (A) (RGBA) format (e.g., RGBA8888 format). Also, the frame buffer may be a certain size, (e.g., a 32-bit triple buffer). For example, at the beginning of a display/graphics subsystem design, a frame buffer may be created as an RGBA8888 format and a 32-bit triple buffer. In some instances, if the frame layers do not use a certain composition (e.g., a GPU or client composition), the frame buffers may be ignored. Also, the layers (e.g., frame layers or display layers associated with display processing) may be directly fetched and composed. For instance, a DPU or hardware composer may directly fetch the layers and then compose the layers.

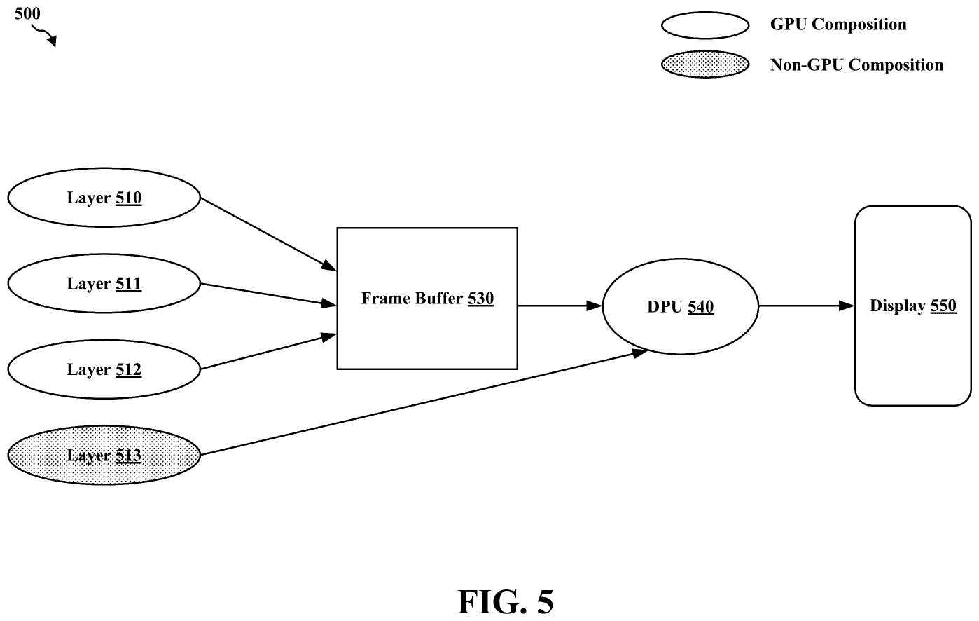

FIG. 5 is a diagram 500 illustrating an example of a layer composition scheme for display processing. More specifically, diagram 500 depicts a layer composition of display layers where certain layers (e.g., layers of a certain composition) are cached in a frame buffer, and some layers are directly fetched and composed by a DPU. As shown in FIG. 5, diagram 500 includes layer 510, layer 511, layer 512, layer 513, frame buffer 530 (e.g., an RGBA8888 format frame buffer), DPU 540, and display 550. FIG. 5 depicts that layers composed at a GPU (i.e., layers associated with GPU composition) may be cached or stored in a frame buffer. For example, layer 510, layer 511, and layer 512 may be composed at a GPU and then cached/stored at frame buffer 530. Alternatively, layers that are not composed at a GPU (i.e., layers associated with non-GPU composition) may be directly fetched and composed at a DPU. For instance, layer 513 may be directly fetched and composed at DPU 540. That is, layer 510, layer 511, and layer 512 may be a certain type of composition (e.g., GPU composition), while layer 513 may be another type of composition (non-GPU composition). After being cached/stored in frame buffer 530, the layer 510, layer 511, and layer 512 may be sent to DPU 540. Further, after processing at DPU 540, the layers 510-513 may be sent to display 550.

Some types of display processing devices (e.g., mobile devices, computers, TVs, or other consumer devices) may utilize different types of lighting techniques for the display. For instance, display processing devices may utilize different types of backlight techniques. Also, for some types of display devices, image quality and power consumption are major factors affecting the performance of the device. In some aspects, display processing devices may utilize different levels of backlight that are dependent on the type of content. That is, display processing devices may utilize content-adaptive backlight (CABL), which is a content-adaptive backlight reduction technique. Content-adaptive backlight techniques may be utilized to adjust the backlight and promote the performance of mobile devices (e.g., liquid crystal displays (LCDs)). In some instances, the goal of content-adaptive backlight techniques may be to reduce the amount of power utilized at the display. For example, content-adaptive backlight techniques may aim to reduce the backlight (e.g., LED backlight) by boosting the pixels, so that there may not be much quality difference to the image. Additionally, content-adaptive backlight techniques may predict the backlight using a cutoff point. The cutoff point may be obtained from the histogram of a particular image or a particular frame.

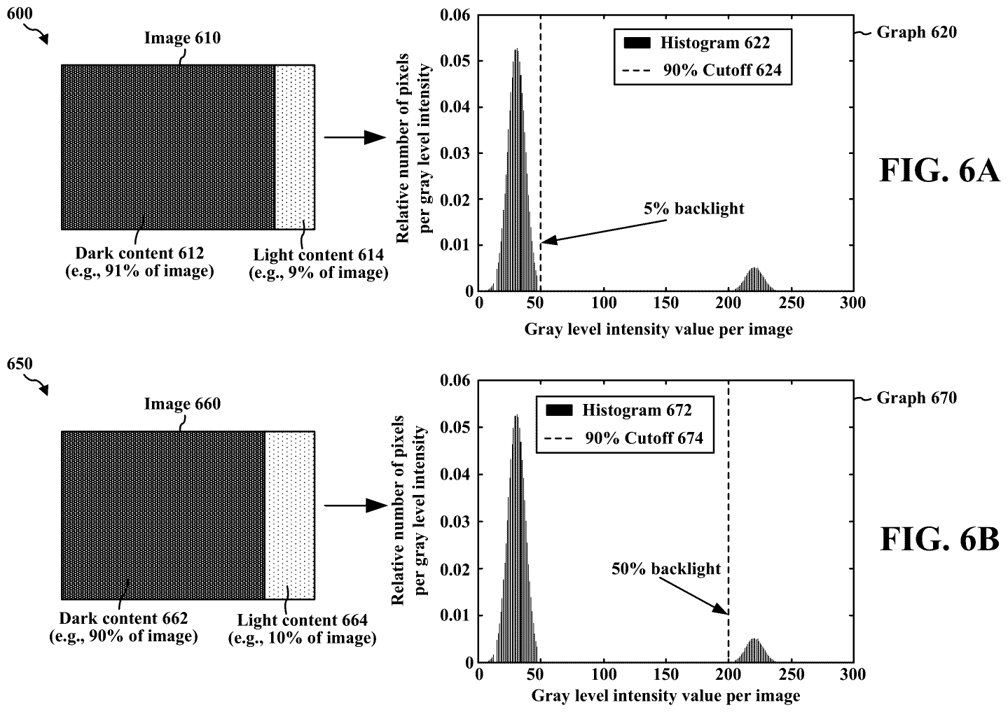

FIG. 6A and FIG. 6B include diagram 600 and diagram 650, respectively, illustrating an example brightness cutoff threshold. More specifically, diagram 600 and diagram 650 illustrate a cutoff threshold (e.g., cutoff 624 and cutoff 674) of a histogram (e.g., histogram 622 and histogram 672) for a corresponding image (e.g., image 610 and image 660). As shown in FIG. 6A, diagram 600 depicts image 610 including dark content 612 (e.g., 91% of the image) and light content 614 (e.g., 9% of the image). Diagram 600 also depicts graph 620 including histogram 622 and cutoff 624 (i.e., a cutoff point or a cutoff threshold). Graph 620 charts the gray level intensity value per image (e.g., image 610) on the x-axis against the relative number of pixels per gray level intensity on the y-axis. As shown in FIG. 6B, diagram 650 depicts image 660 including dark content 662 (e.g., 90% of the image) and light content 664 (e.g., 10% of the image). Diagram 650 also depicts graph 670 including histogram 672 and cutoff 674 (i.e., a cutoff point or a cutoff threshold). Similar to graph 620, graph 670 charts the gray level intensity value per image (e.g., image 660) on the x-axis against the relative number of pixels per gray level intensity on the y-axis.

FIGS. 6A and 6B depict an example of existing content-adaptive backlight (CABL) reduction, in which backlight is determined according to a cutoff point in the histogram. As shown in FIGS. 6A and 6B, the brightness levels of image 610 and image 660 are almost identical. That is, image 610 in FIG. 6A includes 9% light content (light content 614) and 91% dark content (dark content 612), whereas image 660 in FIG. 6B includes 10% light content (light content 664) and 90% dark content (dark content 662). In FIGS. 6A and 6B, the cutoff is defined as a power reduction threshold for the brightness point equal to the 90th percentile of the histogram. That is, in FIGS. 6A and 6B, a brightness level corresponding to the 90^{th} percentile may be a cutoff threshold for a power reduction and corresponding reduction in backlight intensity. As such, if the brightness content varies slightly (e.g., varies between 9% and 11% brightness) there may be a large deviation in cutoff between similar frames. Since the cutoff is based on a hard threshold value, the backlight obtained for both image 610 and image 660 in FIG. 6A and FIG. 6B, respectively, may be drastically different. For example, image 610 and image 660 in FIG. 6A and FIG. 6B, respectively, may result in a backlight level of 5% and 50%, respectively.

As depicted in FIGS. 6A and 6B, for a slight difference in light content (e.g., 9% compared to 10%), a user may perceive a large backlight level fluctuation on the screen at the display device (e.g., a backlight level fluctuation of 5% and 50%). This backlight level fluctuation may be between consecutive frames, which may be perceived as an abrupt backlight level change. For instance, the user may perceive this backlight level fluctuation as a screen brightness change or an error in backlight adjustments. For example, as shown in FIGS. 6A and 6B, if the brightness cutoff to reduce the power and a corresponding reduction in backlight intensity is the 90^{th} percentile of the histogram, there may be backlight intensity flickering for consecutive frames including a brightness content that varies from 9 to 11%. As indicated above, a narrow difference in dark content and bright content in subsequent frames may result in a large difference in backlight levels based on the cutoff (i.e., a power reduction threshold). That is, the cutoff or power reduction threshold may be a threshold at which the power will be reduced based on a corresponding backlight intensity reduction. Additionally, this may result in a problem when tuning algorithms for the visual quality of the display. For example, if a customer wants to tune the cutoff threshold for an application, it may be difficult to do so because the backlights for similar images can be significantly different.

Based on the above, it may be beneficial to avoid stark differences in backlight levels between successive frames. For instance, it may be beneficial to utilize a technique to avoid stark differences in backlight level for small variations in image content between similar frames. Also, it may be beneficial to avoid the use of a hard cutoff threshold that corresponds to the point at which power will be reduced based on a backlight intensity reduction. Further, it may be beneficial to avoid backlight intensity flickering in consecutive frames or abrupt changes in backlight intensity in successive frames.

Aspects of the present disclosure may avoid stark differences in backlight levels between successive, similar frames. For instance, aspects presented herein may utilize a technique to avoid stark differences in backlight level for small variations in image content between successive frames. By doing so, aspects presented herein may avoid abrupt backlight level change in successive frames. Accordingly, aspects presented herein may reduce the likelihood of backlight level fluctuations perceived by the user. Additionally, aspects presented herein may avoid the use of a hard cutoff threshold that corresponds to the point at which power will be reduced based on a backlight intensity reduction. That is, aspects presented herein may avoid backlight intensity flickering in consecutive, similar frames and/or avoid abrupt changes in backlight intensity in successive, similar frames. For example, aspects presented herein may reduce the likelihood that power reduction cutoff points affect the user perception of backlight brightness levels in consecutive frames. As such, aspects presented herein may result in an improvement in the overall visual experience for users of display devices.

Aspects of the present disclosure may utilize a cutoff prediction technique for image histograms associated with backlight control. In some instances, aspects presented herein (e.g., a CPU or DPU driver software at a CPU) may utilize multiple points to calculate a brightness cutoff (i.e., a backlight power reduction cutoff) rather than using a single point to calculate the cutoff. By utilizing multiple points to calculate the cutoff, aspects presented herein may avoid a hard cutoff for backlight power reduction, such that aspects presented herein may avoid backlight intensity flickering in consecutive, similar frames or abrupt changes in backlight intensity between similar frames. For example, if the backlight power reduction cutoff is based on a certain percentile point (e.g., P^{th} percentile point (yₚ)) on the histogram, aspects presented herein (e.g., a CPU or DPU driver software at a CPU) may sample multiple points around the percentile point (yₚ). Additionally, assuming the normalized histogram as an approximate Gaussian distribution, aspects presented herein may model the histogram using the sampled points. Aspects presented herein may also estimate the model parameters for modeling the histogram using the sampled points. Once the model parameters are estimated, aspects presented herein estimate the percentile point (e.g., P^{th} percentile point (yₚ)) of the model. This percentile point may be the updated cutoff or updated brightness cutoff threshold (i.e., the new robust cutoff for backlight power reduction). As indicated above, the updated brightness cutoff threshold may help to avoid backlight intensity flickering in consecutive, similar frames or avoid abrupt changes in backlight intensity in successive, similar frames.

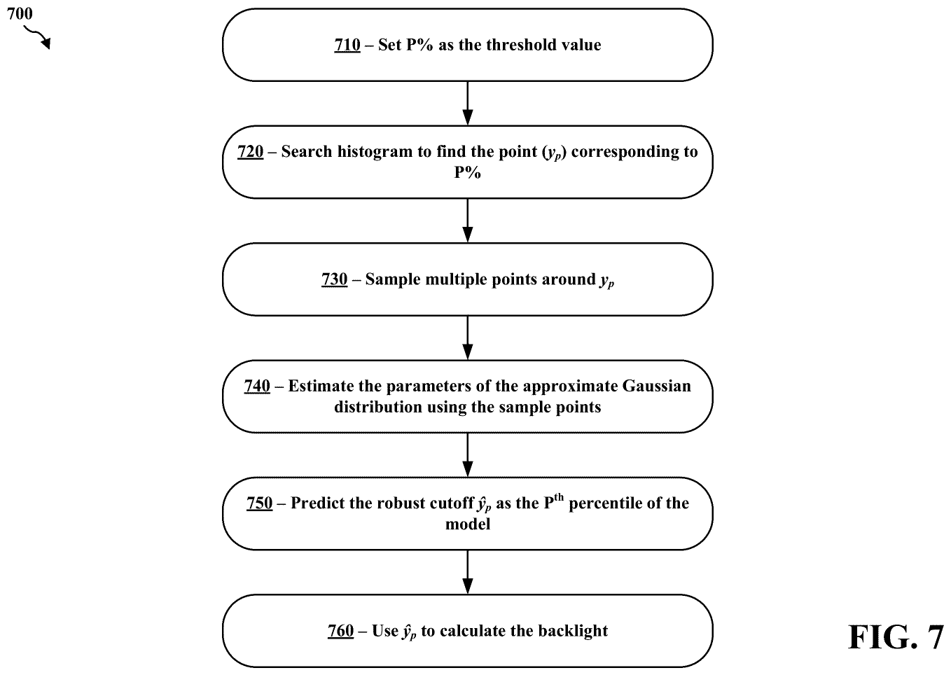

FIG. 7 includes diagram 700 illustrating an example flowchart for a brightness cutoff prediction technique for histograms associated with backlight control. More specifically, diagram 700 illustrates a number of different steps (e.g., step 710, step 720, step 730, step 740, step 750, and step 760) to calculate a brightness cutoff threshold or cutoff for backlight power reduction. As shown in FIG. 7, at step 710, the user/customer tuning the backlight (e.g., a CPU or DPU driver software at a CPU) may set a certain percentage (e.g., P %) as the threshold value. At step 720, aspects presented herein may search a histogram of an image in order to determine the intensity value (e.g., yₚ) that corresponds to P %. At step 730, aspects presented herein may sample multiple points around this intensity value (yₚ). At step 740, aspects presented herein may estimate the parameters of the approximate Gaussian distribution using the sample points (e.g., the sampled points around this intensity value (yₚ)). At step 750, aspects presented herein may calculate or predict an updated brightness cutoff threshold (i.e., a robust cutoff ŷₚ) as the P^{th} percentile of the model. At step 760, aspects presented herein may use the updated brightness cutoff threshold (i.e., a robust cutoff ŷₚ) in order to calculate the backlight value of a current frame. That is, aspects presented herein may map the updated brightness cutoff threshold to a backlight value of the current frame. After doing so, aspects presented herein may transmit an indication of the mapping of the updated brightness cutoff threshold to the backlight value of the current frame. Further, aspects presented herein may transmit an indication of the backlight value of the current frame based on the mapping.

Aspects of the present disclosure may utilize a number of different modeling techniques in order to calculate a brightness cutoff threshold or cutoff for backlight power reduction. In some instances, aspects presented herein may use a smooth function (i.e., a function that does not allow for a sudden transition) to model the normalized cumulative histogram of a frame or image. For example, a function used for the modeling may be:

$$F ( x ) = \frac{1}{1 + {e}^{- ( x - μ ) / σ}} ,$$

where x is a variable, and μ and σ may be calculated or estimated below. The function F(x) may resemble the shape of cumulative distribution function (CDF) of a Gaussian distribution. Also, if H(x) is the histogram of the current frame, the normalized histogram h(x) may be calculated as:

$$h ( x ) = \frac{H ( x )}{{\sum }_{x} H ( x )} = \frac{H ( x )}{M \times N} ,$$

where M and N are the number of rows and columns, respectively, of the frame. Moreover, the normalized cumulative histogram C(x) may be: C(x)=Σᵢ₌₀^{x} h(i), where h(i) is the normalized histogram. As indicated above, μ and σ may be estimated to characterize the function F(x). Equating C(x) to F(x) results in: μ−σY=x, where

$$Y = log ( \frac{1}{C ( x )} - 1 ) .$$

As aspects presented herein may sample (selectively filter in) multiple points from C(x), the parameters μ and σ may be estimated solving the following minimization problem: (μ, σ)=argmin_{μ,σ}Σᵢ|μ−σYᵢ−xᵢ|₂.

Additionally, aspects of the present disclosure may utilize a number of different algorithms in order to calculate a brightness cutoff threshold or cutoff for backlight power reduction. In some aspects, P % may be the threshold set and xₚ may be the corresponding cutoff threshold. Aspects presented herein may calculate normalized histogram h(x) from the frame histogram

$$( e . g . , using h ( x ) = \frac{H ( x )}{{\sum }_{x} H ( x )} = \frac{H ( x )}{M \times N} ) .$$

Also, aspects presented herein may calculate C(x) from h(x) (e.g., using C(x)=Σᵢ₌₀^{x}h(i)). Next, aspects presented herein may selectively filter-in n data points from the cumulative histogram, (C(xᵢ), xᵢ), where the data points are in the neighborhood of the desired cutoff (P, xₚ). Further, aspects presented herein may form matrices A and b using the data points:

$$A = {[ \begin{matrix}1 & - {Y}_{1} \\ ⋮ & ⋮ \\ 1 & - {Y}_{n}\end{matrix} ]}_{n \times 2} , b = {[ \begin{matrix}{x}_{1} \\ ⋮ \\ {x}_{n}\end{matrix} ]}_{( n \times 1 )} , where {Y}_{i} = log ( \frac{1}{C ( {x}_{i} )} - 1 ) .$$

In some instances, aspects presented herein may also calculate:

$$[ \begin{matrix}μ \\ σ\end{matrix} ] ← {( {A}^{T} A )}^{- 1} {A}^{T} b .$$

Additionally, for a targeted threshold of P %, aspects presented herein may determine the cutoff using the following formula: cutoffₚ=μ−σYₚ, where

$${Y}_{P} = log ( \frac{1}{P} - 1 ) .$$

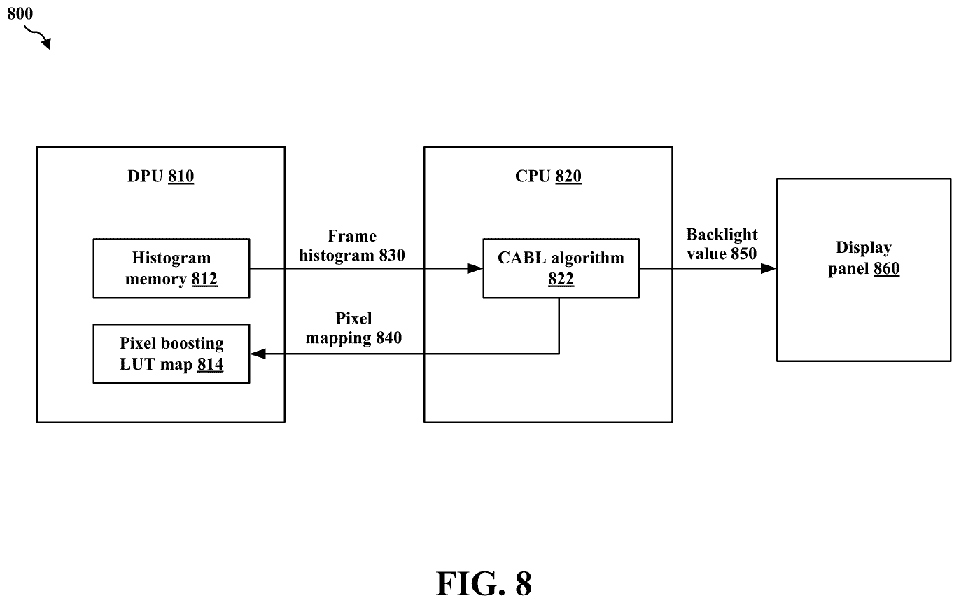

FIG. 8 includes diagram 800 illustrating communication between a DPU, a CPU, and a display panel. More specifically, diagram 800 illustrates a workflow between DPU 810, CPU 820, and display panel 860 for a content-adaptive backlight technique. As shown in FIG. 8, diagram 800 includes DPU 810, histogram memory 812, pixel-boosting look-up table (LUT) map 814, CPU 820, content-adaptive backlight (CABL) algorithm 822, frame histogram 830, pixel mapping 840, backlight value 850, and display panel 860. FIG. 8 depicts that DPU 810 may transmit (e.g., from histogram memory 812) an indication of a frame histogram 830 to the CPU 820 (e.g., the CABL algorithm 822). The CPU 820 may then determine the pixel mapping 840. Also, CPU 820 may determine the backlight value 850. After this, CPU 820 may transmit (e.g., from CABL algorithm 822) the pixel mapping 840 to the DPU 810 (e.g., the pixel-boosting LUT map 814). Further, CPU 820 may transmit (e.g., from CABL algorithm 822) the backlight value 850 to the display panel 860.

As shown in FIG. 8, CPU 820 may obtain a first indication of an initial histogram for a current frame in a set of frames (e.g., obtain frame histogram 830 from DPU 810), where the initial histogram for the current frame is associated with a brightness level of the current frame, where the initial histogram includes a brightness cutoff threshold for the brightness level of the current frame. CPU 820 may also calculate a normalized histogram for the current frame based on the brightness level of the current frame and a total number of pixels in the current frame. Also, CPU 820 may select a set of pixel intensity values from a plurality of pixel intensity values for the current frame, where the set of pixel intensity values is within a range (i.e., a neighborhood) of the threshold pixel intensity level of the brightness cutoff threshold, where the set of pixel intensity values is associated with the corresponding frequency of pixels. CPU 820 may also calculate an updated brightness cutoff threshold based on the set of pixel intensity values for the current frame and an estimated set of parameters assuming a model for pixel intensity distribution of the current frame. Further, CPU 820 may transmit a second indication of a mapping of the updated brightness cutoff threshold to a backlight value of the current frame (e.g., transmit pixel mapping 840 to DPU 810). Moreover, CPU 820 may transmit a third indication of the backlight value of the current frame based on the mapping of the updated brightness cutoff threshold to the backlight value of the current frame (e.g., transmit backlight value 850 to display panel 860).

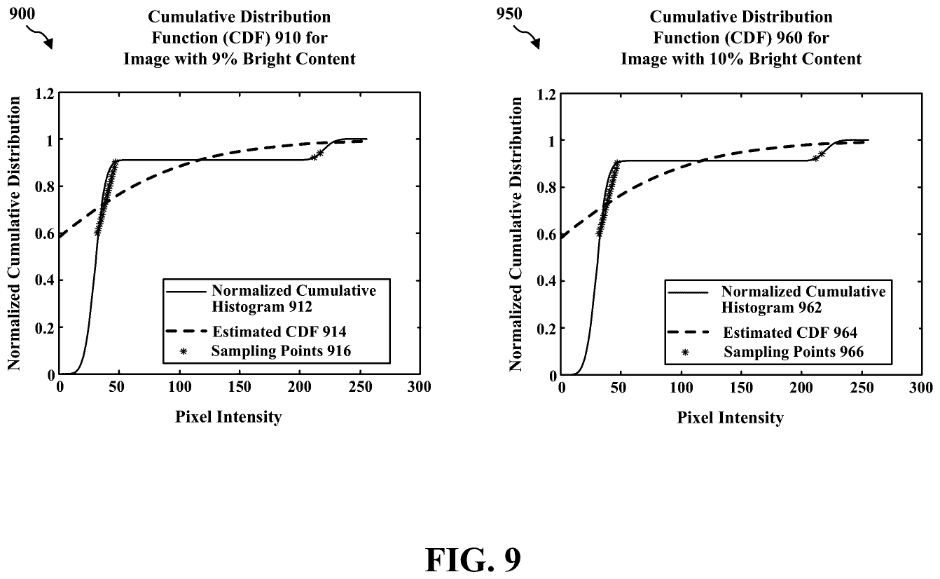

FIG. 9 includes graph 900 and graph 950 illustrating example cumulative distribution functions (CDFs) (e.g., CDF 910 and CDF 960). More specifically, graph 900 depicts the CDF 910 for the image 610 with 9% bright content and graph 950 depicts the CDF 960 for the image 660 with 10% bright content. Graph 900 and graph 950 chart the pixel intensity on the x-axis against the normalized cumulative distribution on the y-axis. Graph 900 illustrates the normalized cumulative histogram 912, the estimated CDF 914, and a number of sampling points 916. Also, graph 950 illustrates normalized cumulative histogram 962, the estimated CDF 964, and a number of sampling points 966. As shown in FIG. 9, graph 900 and 950 are similar in depicting the CDF 910 for an image with 9% bright content and the CDF 960 for an image with 10% bright content. For instance, the normalized cumulative histogram 912 in graph 900 is similar to the normalized cumulative histogram 962 in graph 950. Also, the estimated CDF 914 in graph 900 is similar to the estimated CDF 964 in graph 950.

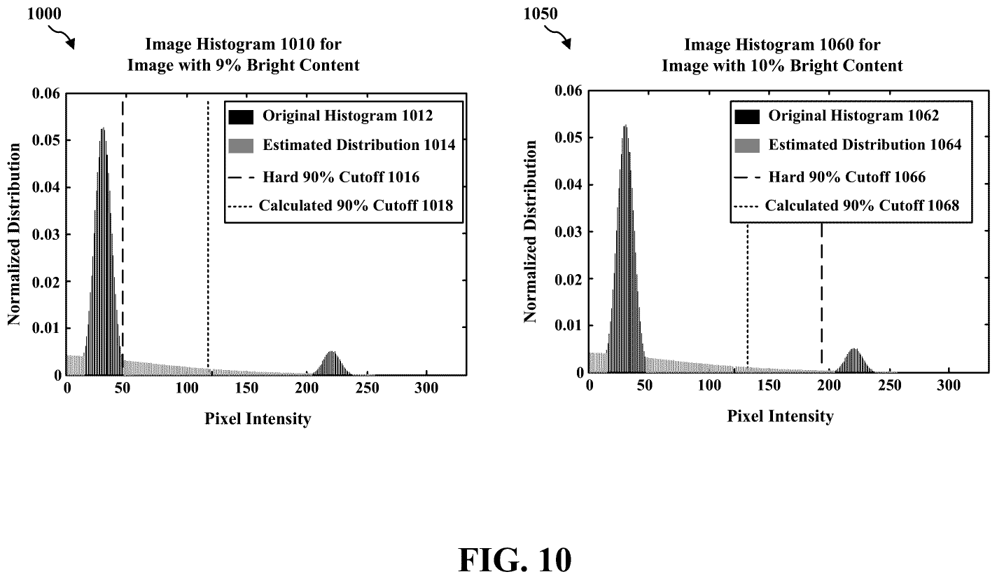

FIG. 10 includes graph 1000 and graph 1050 illustrating example image histograms (e.g., histogram 1010 and histogram 1060). More specifically, graph 1000 depicts the image histogram 1010 for the image 610 with 9% bright content and graph 1050 depicts the image histogram 1060 for the image 660 with 10% bright content. Graph 1000 and graph 1050 chart the pixel intensity on the x-axis against the normalized distribution on the y-axis. Graph 1000 illustrates an original histogram 1012, an estimated distribution 1014, a hard cutoff threshold 1016 (e.g., a 90% cutoff), and a calculated cutoff threshold 1018 (e.g., a 90% cutoff). Also, graph 1050 illustrates an original histogram 1062, an estimated distribution 1064, a hard cutoff threshold 1066 (e.g., a 90% cutoff), and a calculated cutoff threshold 1068 (e.g., a 90% cutoff). As shown in FIG. 10, graph 1000 and 1050 are similar in depicting the histograms for an image with 9% bright content and an image with 10% bright content. For instance, the original histogram 1012 in graph 1000 is similar to the original histogram 1062 in graph 1050, and the estimated distribution 1014 in graph 1000 is similar to the estimated distribution 1064 in graph 1050. However, the hard cutoff threshold 1016 (e.g., a 90% cutoff) for the image with 9% bright content in graph 1000 is different from the hard cutoff threshold 1066 (e.g., a 90% cutoff) for the image with 10% bright content in graph 1050. For instance, the hard cutoff threshold 1016 is around a 50-pixel intensity value, while the hard cutoff threshold 1066 is around a 190-pixel intensity value. This may result in a stark difference in backlight values between the two similar frames (e.g., the image with 9% bright content and the image with 1050 bright content).

As shown in FIG. 10, aspects presented herein may calculate an updated cutoff (e.g., an updated brightness cutoff threshold) that is similar between two similar frames. For instance, calculated cutoff threshold 1018 (e.g., a 90% cutoff) for the image with 9% bright content in graph 1000 is similar to the calculated cutoff threshold 1068 (e.g., a 90% cutoff) for the image with 10% bright content in graph 1050. That is calculated cutoff threshold 1018 is around a 120-pixel intensity value while calculated cutoff threshold 1068 is around a 130-pixel intensity value. This may result in little to no difference in backlight values between the two similar frames (e.g., the image with 9% bright content and the image with 10% bright content). Accordingly, calculated cutoff threshold 1018 and calculated cutoff threshold 1068 may help to predict consistent cutoffs (i.e., an estimated 90% cutoff) across the two similar frames (e.g., including 9% and 10% bright content). That is, calculated cutoff threshold 1018 and calculated cutoff threshold 1068 may avoid backlight intensity flickering in consecutive, similar frames and/or avoid abrupt changes in backlight intensity in successive, similar frames. For example, calculated cutoff threshold 1018 and calculated cutoff threshold 1068 may reduce the likelihood that power reduction cutoff points affect the user perception of backlight brightness levels in consecutive frames. As such, calculated cutoff threshold 1018 and calculated cutoff threshold 1068 may result in an improvement in the overall visual experience for users of display devices.

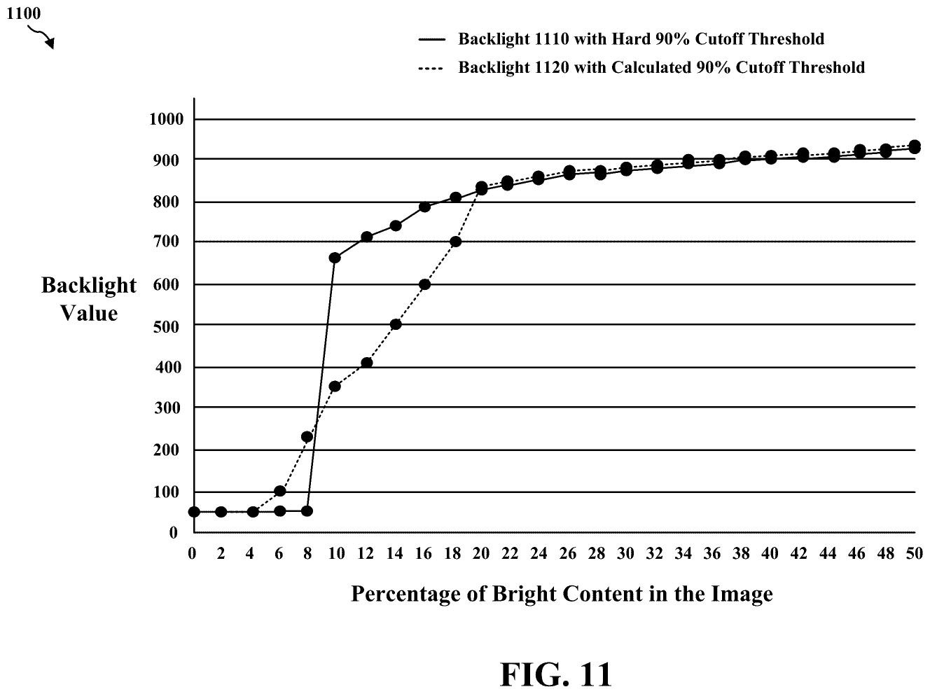

FIG. 11 includes graph 1100 illustrating example backlight values for different images with varying brightness content. More specifically, graph 1100 depicts a backlight value (e.g., backlight 1110) for a hard cutoff threshold and a backlight value (e.g., backlight 1120) for a calculated cutoff threshold. Graph 1100 charts the percentage of bright content in an image on the x-axis against the backlight value on the y-axis (e.g., a backlight value in lumens). As shown in FIG. 11, the hard cutoff threshold may result in a steep change in the backlight 1110 for certain bright content percentages (e.g., 8-10%). Also, the calculated cutoff threshold may result in a smooth change in the backlight 1120 for those same bright content percentages (e.g., 8-10%). Accordingly, the calculated cutoff threshold according to aspects presented herein may reduce the likelihood that power reduction cutoff points affect the user perception of backlight brightness levels in consecutive, similar frames. As shown in FIG. 11, the calculated cutoff threshold may use multiple points in a histogram. Also, the calculated cutoff threshold may utilize model the region of interest effectively while ignoring rest of the data for an image. Further, the calculated cutoff threshold may be robust towards change in histograms (i.e., small change in histogram may not cause drastic change in cutoff). By doing so, the calculated cutoff threshold may improve the image quality by eliminating screen brightness fluctuations between successive frames in similar scenes.

As shown in FIG. 11, a hard brightness cutoff threshold may result in a stark difference in image quality between successive frames. This may be due to very different backlight predictions between the successive frames. However, with the calculated brightness cutoff threshold according to the aspects presented herein, there may be a consistent image quality between successive frames. This may be due to similar backlight predictions between the successive frames. Also, the calculated brightness cutoff threshold according to the aspects presented herein may result in a brightness level with gradual increase in pixel intensity between successive frames. As further shown in FIG. 11, this gradual increase in pixel intensity between successive frames may be applicable to frames with similar brightness levels (e.g., a current frame with 9% bright content and a subsequent frame with 10% bright content).

Aspects of the present disclosure may include a number of benefits or advantages. For instance, aspects presented herein may avoid stark differences in backlight levels between successive, similar frames. That is, aspects presented herein may utilize a technique to avoid stark differences in backlight level for small variations in image content between successive frames. By doing so, aspects presented herein may avoid abrupt backlight level change in successive frames. As such, aspects presented herein may reduce the likelihood that a user may perceive a backlight level fluctuation as a screen brightness change or error based on the stark difference in backlight levels in successive, similar frames. Also, aspects presented herein may avoid the use of a hard cutoff threshold that corresponds to a single point that matches to the threshold set. Further, aspects presented herein may avoid backlight intensity flickering in consecutive, similar frames and/or avoid abrupt changes in backlight intensity in successive, similar frames. For example, aspects presented herein may reduce the likelihood that power reduction cutoff points affect the user perception of backlight brightness levels in consecutive, similar frames. Accordingly, aspects presented herein may result in an improvement in the overall visual experience for users of display devices.

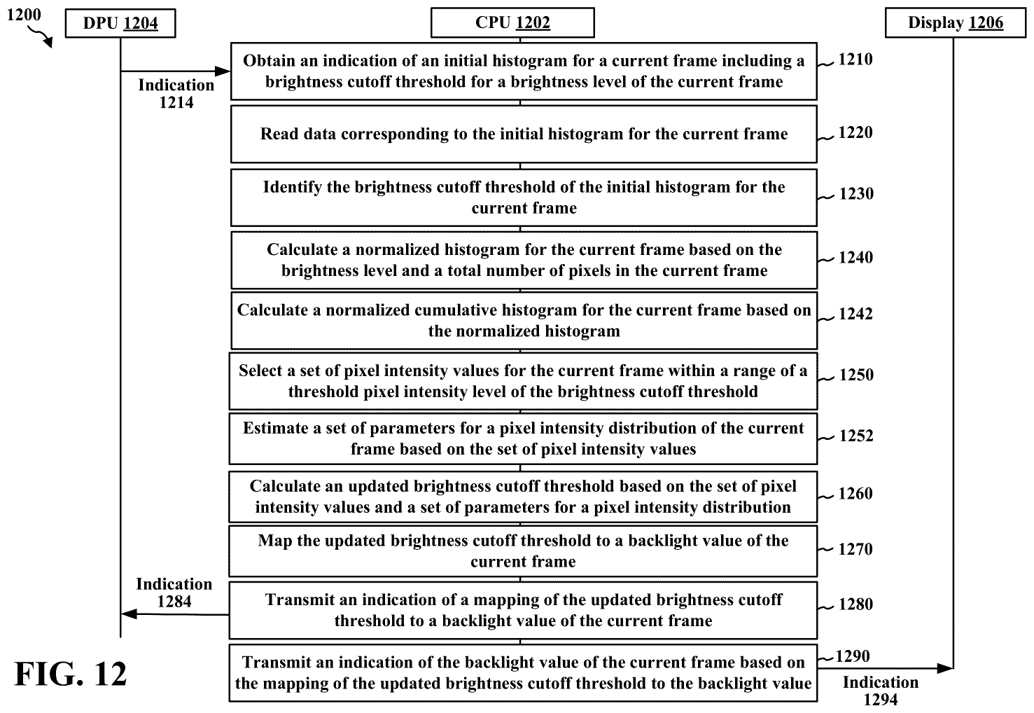

FIG. 12 is a communication flow diagram 1200 of display processing in accordance with one or more techniques of this disclosure. As shown in FIG. 12, diagram 1200 includes example communications between CPU 1202 (e.g., a DPU driver, DPU driver software, another central processor, or display processor), DPU 1204, and display 1206 (e.g., a panel or display panel), in accordance with one or more techniques of this disclosure.

At 1210, CPU 1202 may obtain a first indication of an initial histogram for a current frame in a set of frames (e.g., CPU 1202 may obtain indication 1214 from DPU 1204), where the initial histogram for the current frame is associated with a brightness level of the current frame, where the initial histogram includes a brightness cutoff threshold for the brightness level of the current frame. The brightness cutoff threshold may be configurable based on a pixel distortion level of the current frame. Also, the brightness level of the current frame may be a gray level intensity, such that the brightness cutoff threshold may be associated with the gray level intensity of the current frame. Further, the initial histogram for the current frame may be a brightness-level histogram for the current frame, and the initial histogram for the current frame may be associated with display processing (e.g., at a DPU). In some aspects, obtaining the first indication of the initial histogram for the current frame may include: receiving the first indication of the initial histogram for the current frame (e.g., from a DPU). That is, the CPU may receive the first indication of the initial histogram for the current frame (e.g., from a DPU).

At 1220, CPU 1202 may read data corresponding to the initial histogram for the current frame, where the data is associated with the brightness level of the current frame. In some aspects, reading the data corresponding to the initial histogram for the current frame may include: reading the data corresponding to the initial histogram for the current frame from a histogram memory (e.g., at a DPU). That is, the CPU may read the data corresponding to the initial histogram for the current frame from a histogram memory (e.g., at a DPU).

At 1230, CPU 1202 may identify the brightness cutoff threshold of the initial histogram for the current frame based on the first indication of the initial histogram for the current frame.

At 1240, CPU 1202 may calculate a normalized histogram for the current frame based on the brightness level of the current frame and a total number of pixels in the current frame. In some aspects, calculating the normalized histogram for the current frame may include: dividing a number of pixels per-brightness level of the current frame by the total number of pixels in the current frame. That is, the CPU may divide a number of pixels per-brightness level of the current frame by the total number of pixels in the current frame.

At 1242, CPU 1202 may calculate a normalized cumulative histogram for the current frame based on the normalized histogram. In some aspects, calculating the normalized cumulative histogram for the current frame may include: summing a normalized frequency for each pixel intensity level of a set of pixel intensity levels in the normalized histogram. That is, the CPU may sum a normalized frequency for each pixel intensity level of a set of pixel intensity levels in the normalized histogram.

At 1250, CPU 1202 may select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels. In some aspects, selecting the set of pixel intensity values may include: filtering the set of pixel intensity values within a range (i.e., neighborhood) of the threshold pixel intensity level of the brightness cutoff threshold. That is, the CPU may filter the set of pixel intensity values within a range of the threshold pixel intensity level of the brightness cutoff threshold. Additionally, the set of pixel intensity values may be associated with a normalized cumulative distribution of the current frame. Also, a size of the range of the threshold pixel intensity level may be configurable based on a transition rate of a backlight level between the current frame and a subsequent frame in the set of frames.

At 1252, CPU 1202 may estimate a set of parameters for a pixel intensity distribution of the current frame based on the set of pixel intensity values for the current frame, where an updated brightness cutoff threshold is calculated based on the set of pixel intensity values and the estimated set of parameters. A model for the pixel intensity distribution of the current frame may be an approximate Gaussian distribution model that is associated with an elimination of abrupt variations in pixel intensity frequencies for the current frame.

At 1260, CPU 1202 may calculate an updated brightness cutoff threshold based on the set of pixel intensity values for the current frame and a set of parameters for a pixel intensity distribution of the current frame.

At 1270, CPU 1202 may map the updated brightness cutoff threshold to the backlight value of the current frame prior to transmitting a second indication of the mapping of the updated brightness cutoff threshold to the backlight value of the current frame.

At 1280, CPU 1202 may transmit a second indication of a mapping of the updated brightness cutoff threshold to a backlight value of the current frame (e.g., CPU 1202 may transmit indication 1284 to DPU 1204).

At 1290, CPU 1202 may transmit a third indication of the backlight value of the current frame based on the mapping of the updated brightness cutoff threshold to the backlight value of the current frame (e.g., CPU 1202 may transmit indication 1294 to display 1206).

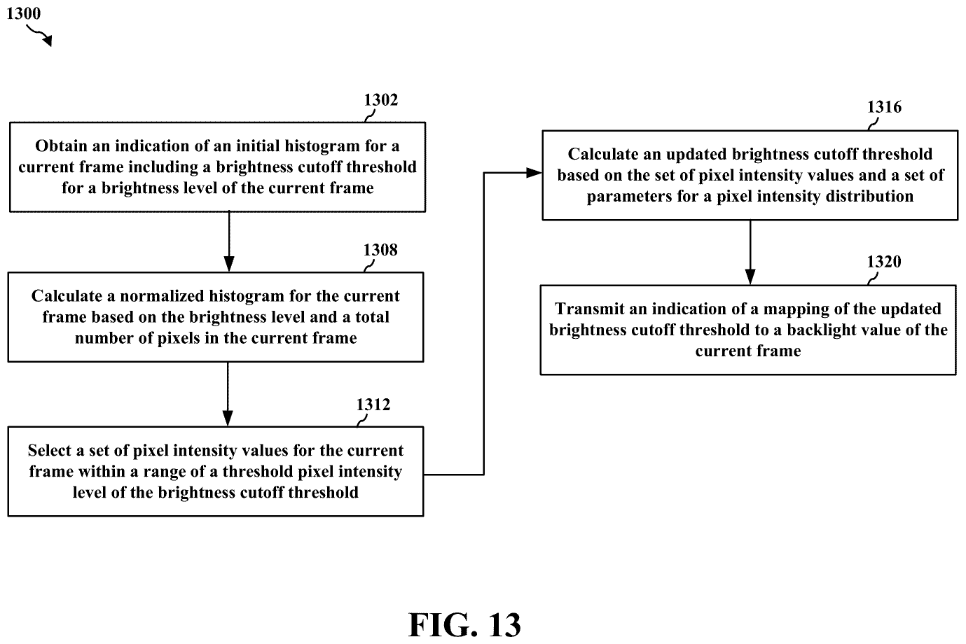

FIG. 13 is a flowchart 1300 of an example method of display processing in accordance with one or more techniques of this disclosure. The method may be performed by a CPU (or other central processor), a DPU driver, DPU driver software, a DPU (or other display processor), a GPU (or other graphics processor), a DDIC, an apparatus for display processing, a wireless communication device, and/or any apparatus that may perform display processing as used in connection with the examples of FIGS. 1-12.

At 1302, the CPU may obtain a first indication of an initial histogram for a current frame in a set of frames, where the initial histogram for the current frame is associated with a brightness level of the current frame, where the initial histogram includes a brightness cutoff threshold for the brightness level of the current frame, as described in connection with the examples in FIGS. 1-12. For example, as described in 1210 of FIG. 12, CPU 1202 may obtain a first indication of an initial histogram for a current frame in a set of frames, where the initial histogram for the current frame is associated with a brightness level of the current frame, where the initial histogram includes a brightness cutoff threshold for the brightness level of the current frame. Further, step 1302 may be performed by processing unit 120 in FIG. 1. The brightness cutoff threshold may be configurable based on a pixel distortion level of the current frame. Also, the brightness level of the current frame may be a gray level intensity, such that the brightness cutoff threshold may be associated with the gray level intensity of the current frame. Further, the initial histogram for the current frame may be a brightness-level histogram for the current frame, and the initial histogram for the current frame may be associated with display processing (e.g., at a DPU). In some aspects, obtaining the first indication of the initial histogram for the current frame may include: receiving the first indication of the initial histogram for the current frame (e.g., from a DPU). That is, the CPU may receive the first indication of the initial histogram for the current frame (e.g., from a DPU).

At 1308, the CPU may calculate a normalized histogram for the current frame based on the brightness level of the current frame and a total number of pixels in the current frame. In some aspects, calculating the normalized histogram for the current frame may include: dividing a number of pixels per-brightness level of the current frame by the total number of pixels in the current frame, as described in connection with the examples in FIGS. 1-12. For example, as described in 1240 of FIG. 12, CPU 1202 may calculate a normalized histogram for the current frame based on the brightness level of the current frame and a total number of pixels in the current frame. Further, step 1308 may be performed by processing unit 120 in FIG. 1. That is, the CPU may divide a number of pixels per-brightness level of the current frame by the total number of pixels in the current frame.

At 1312, the CPU may select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels, as described in connection with the examples in FIGS. 1-12. For example, as described in 1250 of FIG. 12, CPU 1202 may select a set of pixel intensity values from a plurality of pixel intensity values for the current frame, where the set of pixel intensity values is within a threshold pixel intensity level of the brightness cutoff threshold, where the set of pixel intensity values is associated with a frequency of a brightness distribution for the normalized histogram. Further, step 1312 may be performed by processing unit 120 in FIG. 1. In some aspects, selecting the set of pixel intensity values may include: filtering the set of pixel intensity values within a range (i.e., neighborhood) of the threshold pixel intensity level of the brightness cutoff threshold. That is, the CPU may filter the set of pixel intensity values within a range of the threshold pixel intensity level of the brightness cutoff threshold. Additionally, the set of pixel intensity values may be associated with a normalized cumulative distribution of the current frame. Also, a size of the range of the threshold pixel intensity level may be configurable based on a transition rate of a backlight level between the current frame and a subsequent frame in the set of frames.

At 1316, the CPU may calculate an updated brightness cutoff threshold based on the set of pixel intensity values for the current frame and a set of parameters for a pixel intensity distribution of the current frame, as described in connection with the examples in FIGS. 1-12. For example, as described in 1260 of FIG. 12, CPU 1202 may calculate an updated brightness cutoff threshold based on the set of pixel intensity values for the current frame and a set of parameters for a pixel intensity distribution of the current frame. Further, step 1316 may be performed by processing unit 120 in FIG. 1.

At 1320, the CPU may transmit a second indication of a mapping of the updated brightness cutoff threshold to a backlight value of the current frame, as described in connection with the examples in FIGS. 1-12. For example, as described in 1280 of FIG. 12, CPU 1202 may transmit a second indication of a mapping of the updated brightness cutoff threshold to a backlight value of the current frame. Further, step 1320 may be performed by processing unit 120 in FIG. 1.

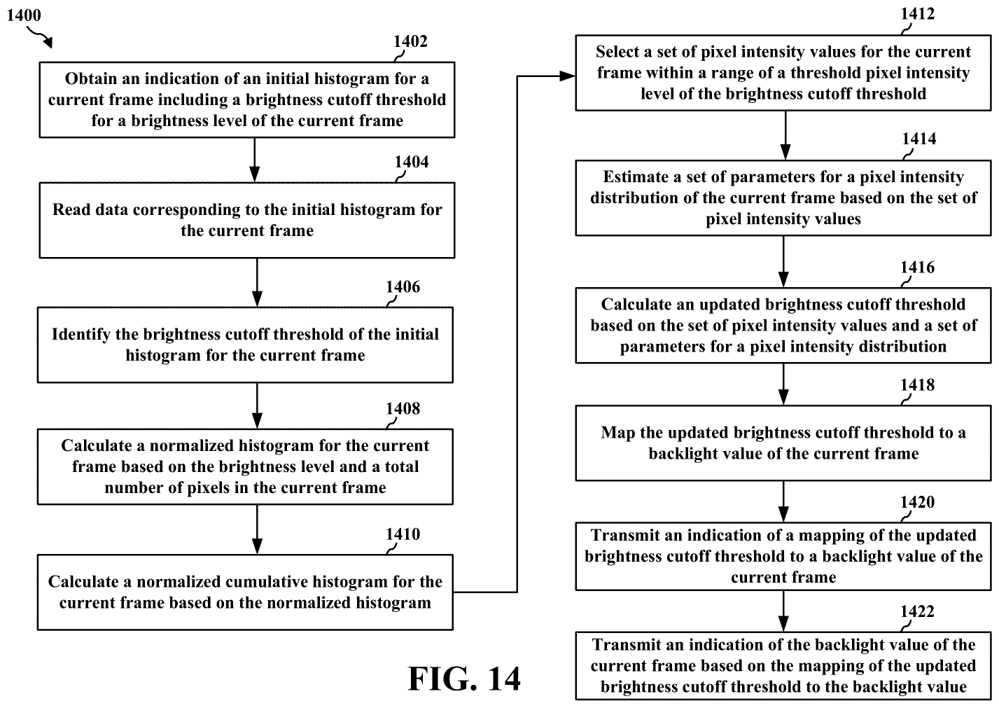

FIG. 14 is a flowchart 1400 of an example method of display processing in accordance with one or more techniques of this disclosure. The method may be performed by a CPU (or other central processor), a DPU driver, DPU driver software, a DPU (or other display processor), a GPU (or other graphics processor), a DDIC, an apparatus for display processing, a wireless communication device, and/or any apparatus that may perform display processing as used in connection with the examples of FIGS. 1-12.

At 1402, the CPU may obtain a first indication of an initial histogram for a current frame in a set of frames, where the initial histogram for the current frame is associated with a brightness level of the current frame, where the initial histogram includes a brightness cutoff threshold for the brightness level of the current frame, as described in connection with the examples in FIGS. 1-12. For example, as described in 1210 of FIG. 12, CPU 1202 may obtain a first indication of an initial histogram for a current frame in a set of frames, where the initial histogram for the current frame is associated with a brightness level of the current frame, where the initial histogram includes a brightness cutoff threshold for the brightness level of the current frame. Further, step 1402 may be performed by processing unit 120 in FIG. 1. The brightness cutoff threshold may be configurable based on a pixel distortion level of the current frame. Also, the brightness level of the current frame may be a gray level intensity, such that the brightness cutoff threshold may be associated with the gray level intensity of the current frame. Further, the initial histogram for the current frame may be a brightness-level histogram for the current frame, and the initial histogram for the current frame may be associated with display processing (e.g., at a DPU). In some aspects, obtaining the first indication of the initial histogram for the current frame may include: receiving the first indication of the initial histogram for the current frame (e.g., from a DPU). That is, the CPU may receive the first indication of the initial histogram for the current frame (e.g., from a DPU).

At 1404, the CPU may read data corresponding to the initial histogram for the current frame, where the data is associated with the brightness level of the current frame, as described in connection with the examples in FIGS. 1-12. For example, as described in 1220 of FIG. 12, CPU 1202 may read data corresponding to the initial histogram for the current frame, where the data is associated with the brightness level of the current frame. Further, step 1404 may be performed by processing unit 120 in FIG. 1. In some aspects, reading the data corresponding to the initial histogram for the current frame may include: reading the data corresponding to the initial histogram for the current frame from a histogram memory (e.g., at a DPU). That is, the CPU may read the data corresponding to the initial histogram for the current frame from a histogram memory (e.g., at a DPU).

At 1406, the CPU may identify the brightness cutoff threshold of the initial histogram for the current frame based on the first indication of the initial histogram for the current frame, as described in connection with the examples in FIGS. 1-12. For example, as described in 1230 of FIG. 12, CPU 1202 may identify the brightness cutoff threshold of the initial histogram for the current frame based on the first indication of the initial histogram for the current frame. Further, step 1406 may be performed by processing unit 120 in FIG. 1.

At 1408, the CPU may calculate a normalized histogram for the current frame based on the brightness level of the current frame and a total number of pixels in the current frame. In some aspects, calculating the normalized histogram for the current frame may include: dividing a number of pixels per-brightness level of the current frame by the total number of pixels in the current frame, as described in connection with the examples in FIGS. 1-12. For example, as described in 1240 of FIG. 12, CPU 1202 may calculate a normalized histogram for the current frame based on the brightness level of the current frame and a total number of pixels in the current frame. Further, step 1408 may be performed by processing unit 120 in FIG. 1. That is, the CPU may divide a number of pixels per-brightness level of the current frame by the total number of pixels in the current frame.

At 1410, the CPU may calculate a normalized cumulative histogram for the current frame based on the normalized histogram, as described in connection with the examples in FIGS. 1-12. For example, as described in 1242 of FIG. 12, CPU 1202 may calculate a normalized cumulative histogram for the current frame based on the normalized histogram. Further, step 1410 may be performed by processing unit 120 in FIG. 1. In some aspects, calculating the normalized cumulative histogram for the current frame may include: summing a normalized frequency for each pixel intensity level of a set of pixel intensity levels in the normalized histogram. That is, the CPU may sum a normalized frequency for each pixel intensity level of a set of pixel intensity levels in the normalized histogram.

At 1412, the CPU may select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels, as described in connection with the examples in FIGS. 1-12. For example, as described in 1250 of FIG. 12, CPU 1202 may select a set of pixel intensity values from a plurality of pixel intensity values for the current frame, where the set of pixel intensity values is within a threshold pixel intensity level of the brightness cutoff threshold, where the set of pixel intensity values is associated with a frequency of a brightness distribution for the normalized histogram. Further, step 1412 may be performed by processing unit 120 in FIG. 1. In some aspects, selecting the set of pixel intensity values may include: filtering the set of pixel intensity values within a range (i.e., neighborhood) of the threshold pixel intensity level of the brightness cutoff threshold. That is, the CPU may filter the set of pixel intensity values within a range of the threshold pixel intensity level of the brightness cutoff threshold. Additionally, the set of pixel intensity values may be associated with a normalized cumulative distribution of the current frame. Also, a size of the range of the threshold pixel intensity level may be configurable based on a transition rate of a backlight level between the current frame and a subsequent frame in the set of frames.

At 1414, the CPU may estimate a set of parameters for a pixel intensity distribution of the current frame based on the set of pixel intensity values for the current frame, where an updated brightness cutoff threshold is calculated based on the set of pixel intensity values and the estimated set of parameters, as described in connection with the examples in FIGS. 1-12. For example, as described in 1252 of FIG. 12, CPU 1202 may estimate a set of parameters for a pixel intensity distribution of the current frame based on the set of pixel intensity values for the current frame, where an updated brightness cutoff threshold is calculated based on the set of pixel intensity values and the estimated set of parameters. Further, step 1414 may be performed by processing unit 120 in FIG. 1. A model for the pixel intensity distribution of the current frame may be an approximate Gaussian distribution model that is associated with an elimination of abrupt variations in pixel intensity frequencies for the current frame.

At 1416, the CPU may calculate an updated brightness cutoff threshold based on the set of pixel intensity values for the current frame and a set of parameters for a pixel intensity distribution of the current frame, as described in connection with the examples in FIGS. 1-12. For example, as described in 1260 of FIG. 12, CPU 1202 may calculate an updated brightness cutoff threshold based on the set of pixel intensity values for the current frame and a set of parameters for a pixel intensity distribution of the current frame. Further, step 1416 may be performed by processing unit 120 in FIG. 1.

At 1418, the CPU may map the updated brightness cutoff threshold to the backlight value of the current frame prior to transmitting a second indication of the mapping of the updated brightness cutoff threshold to the backlight value of the current frame, as described in connection with the examples in FIGS. 1-12. For example, as described in 1270 of FIG. 12, CPU 1202 may map the updated brightness cutoff threshold to the backlight value of the current frame prior to transmitting a second indication of the mapping of the updated brightness cutoff threshold to the backlight value of the current frame. Further, step 1418 may be performed by processing unit 120 in FIG. 1.

At 1420, the CPU may transmit a second indication of a mapping of the updated brightness cutoff threshold to a backlight value of the current frame, as described in connection with the examples in FIGS. 1-12. For example, as described in 1280 of FIG. 12, CPU 1202 may transmit a second indication of a mapping of the updated brightness cutoff threshold to a backlight value of the current frame. Further, step 1420 may be performed by processing unit 120 in FIG. 1.

At 1422, the CPU may transmit a third indication of the backlight value of the current frame based on the mapping of the updated brightness cutoff threshold to the backlight value of the current frame, as described in connection with the examples in FIGS. 1-12. For example, as described in 1290 of FIG. 12, CPU 1202 may transmit a third indication of the backlight value of the current frame based on the mapping of the updated brightness cutoff threshold to the backlight value of the current frame. Further, step 1422 may be performed by processing unit 120 in FIG. 1.

In configurations, a method or an apparatus for display processing is provided. The apparatus may be a CPU (or other central processor), a DPU (or other display processor), a GPU (or other graphics processor), a DPU driver, DPU driver software, a DDIC, an apparatus for display processing, and/or some other processor that may perform display processing. In aspects, the apparatus may be the processing unit 120 within the device 104, or may be some other hardware within the device 104 or another device. The apparatus, e.g., processing unit 120, may include means for obtaining a first indication of an initial histogram for a current frame in a set of frames, where the initial histogram for the current frame is associated with a brightness level of the current frame, where the initial histogram includes a brightness cutoff threshold for the brightness level of the current frame. The apparatus, e.g., processing unit 120, may also include means for calculating a normalized histogram for the current frame based on the brightness level of the current frame and a total number of pixels in the current frame. The apparatus, e.g., processing unit 120, may also include means for selecting a set of pixel intensity values from a plurality of pixel intensity values for the current frame, where the set of pixel intensity values is within a threshold pixel intensity level of the brightness cutoff threshold, where the set of pixel intensity values is associated with a frequency of a brightness distribution for the normalized histogram. The apparatus, e.g., processing unit 120, may also include means for calculating an updated brightness cutoff threshold based on the set of pixel intensity values for the current frame and a set of parameters for a pixel intensity distribution of the current frame. The apparatus, e.g., processing unit 120, may also include means for transmitting a second indication of a mapping of the updated brightness cutoff threshold to a backlight value of the current frame. The apparatus, e.g., processing unit 120, may also include means for mapping the updated brightness cutoff threshold to the backlight value of the current frame prior to transmitting the second indication of the mapping of the updated brightness cutoff threshold to the backlight value of the current frame. The apparatus, e.g., processing unit 120, may also include means for transmitting a third indication of the backlight value of the current frame based on the mapping of the updated brightness cutoff threshold to the backlight value of the current frame. The apparatus, e.g., processing unit 120, may also include means for estimating the set of parameters for the pixel intensity distribution of the current frame based on the set of pixel intensity values for the current frame, where the updated brightness cutoff threshold is calculated based on the set of pixel intensity values and the estimated set of parameters. The apparatus, e.g., processing unit 120, may also include means for calculating a normalized cumulative histogram for the current frame based on the normalized histogram. The apparatus, e.g., processing unit 120, may also include means for identifying the brightness cutoff threshold of the initial histogram for the current frame based on the first indication of the initial histogram for the current frame. The apparatus, e.g., processing unit 120, may also include means for reading data corresponding to the initial histogram for the current frame, where the data is associated with the brightness level of the current frame.

The subject matter described herein may be implemented to realize one or more benefits or advantages. For instance, the described display processing techniques may be used by a CPU, a central processor, a DPU driver, DPU driver software, a DPU, a display processor, a GPU, or some other processor that may perform display processing to implement the cutoff prediction techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize cutoff prediction techniques in order to improve memory bandwidth efficiency and/or increase processing speed at a CPU, a DPU or a GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C. B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for display processing, including a memory and at least one processor coupled to the memory and, based at least in part on information stored in the memory, the at least one processor is configured to: obtain a first indication of an initial histogram for a current frame in a set of frames, where the initial histogram for the current frame is associated with a brightness level of the current frame, where the initial histogram includes a brightness cutoff threshold for the brightness level of the current frame; calculate a normalized histogram for the current frame based on the brightness level of the current frame and a total number of pixels in the current frame; select a set of pixel intensity values from a plurality of pixel intensity values for the current frame, where the set of pixel intensity values is within a threshold pixel intensity level of the brightness cutoff threshold, where the set of pixel intensity values is associated with a corresponding frequency of pixels; calculate an updated brightness cutoff threshold based on the set of pixel intensity values for the current frame and a set of parameters for a pixel intensity distribution of the current frame; and transmit a second indication of a mapping of the updated brightness cutoff threshold to a backlight value of the current frame.

Aspect 2 is the apparatus of aspect 1, where the at least one processor is further configured to: map the updated brightness cutoff threshold to the backlight value of the current frame prior to being configured to transmit the second indication of the mapping of the updated brightness cutoff threshold to the backlight value of the current frame.

Aspect 3 is the apparatus of aspect 2, where the at least one processor is further configured to: transmit a third indication of the backlight value of the current frame based on the mapping of the updated brightness cutoff threshold to the backlight value of the current frame.

Aspect 4 is the apparatus of any of aspects 1 to 3, where the at least one processor is further configured to: estimate the set of parameters for the pixel intensity distribution of the current frame based on the set of pixel intensity values for the current frame, where the at least one processor is configured to calculate the updated brightness cutoff threshold based on the set of pixel intensity values and the estimated set of parameters.

Aspect 5 is the apparatus of any of aspects 1 to 4, where the at least one processor is further configured to: calculate a normalized cumulative histogram for the current frame based on the normalized histogram.

Aspect 6 is the apparatus of aspect 5, where to calculate the normalized cumulative histogram for the current frame, the at least one processor is configured to: sum a normalized frequency for each pixel intensity level of a set of pixel intensity levels in the normalized histogram.

Aspect 7 is the apparatus of any of aspects 1 to 6, where to calculate the normalized histogram for the current frame, the at least one processor is configured to: divide a number of pixels per-brightness level of the current frame by the total number of pixels in the current frame.

Aspect 8 is the apparatus of any of aspects 1 to 7, where the set of pixel intensity values is associated with a normalized cumulative distribution of the current frame.

Aspect 9 is the apparatus of any of aspects 1 to 8, where to select the set of pixel intensity values, the at least one processor is configured to: filter the set of pixel intensity values within a range of the threshold pixel intensity level of the brightness cutoff threshold.

Aspect 10 is the apparatus of aspect 9, where a size of the range of the threshold pixel intensity level is configurable based on a transition rate of a backlight level between the current frame and a subsequent frame in the set of frames.

Aspect 11 is the apparatus of any of aspects 1 to 10, where the at least one processor is further configured to: identify the brightness cutoff threshold of the initial histogram for the current frame based on the first indication of the initial histogram for the current frame.

Aspect 12 is the apparatus of aspect 11, where the brightness cutoff threshold is configurable based on a pixel distortion level of the current frame.

Aspect 13 is the apparatus of any of aspects 11 to 12, where the brightness level of the current frame is a gray level intensity, such that the brightness cutoff threshold is associated with the gray level intensity of the current frame.

Aspect 14 is the apparatus of any of aspects 1 to 13, where the at least one processor is further configured to: read data corresponding to the initial histogram for the current frame, where the data is associated with the brightness level of the current frame.

Aspect 15 is the apparatus of aspect 14, where to read the data corresponding to the initial histogram for the current frame, the at least one processor is configured to: read the data corresponding to the initial histogram for the current frame from a histogram memory.

Aspect 16 is the apparatus of any of aspects 1 to 15, where the initial histogram for the current frame is a brightness-level histogram for the current frame, and where the initial histogram for the current frame is associated with the display processing.

Aspect 17 is the apparatus of any of aspects 1 to 16, where a model for the pixel intensity distribution of the current frame is an approximate Gaussian distribution model that is associated with an elimination of abrupt variations in pixel intensity frequencies for the current frame.

Aspect 18 is the apparatus of any of aspects 1 to 17, further including at least one of an antenna or a transceiver coupled to the at least one processor, where to obtain the first indication of the initial histogram for the current frame, the at least one processor is configured to: receive, via at least one of the antenna or the transceiver, the first indication of the initial histogram for the current frame.

Aspect 19 is a method of display processing for implementing any of aspects 1 to 18.

Aspect 20 is an apparatus for display processing including means for implementing any of aspects 1 to 18.

Aspect 21 is a computer-readable medium (e.g., a non-transitory computer-readable medium) storing computer executable code, the code when executed by at least one processor causes the at least one processor to implement any of aspects 1 to 18.

1. An apparatus for display processing, comprising:
memory; and
at least one processor coupled to the memory and, based at least in part on information stored in the memory, the at least one processor is configured to:
obtain a first indication of an initial histogram for a current frame in a set of frames, wherein the initial histogram for the current frame is associated with a brightness level of the current frame, wherein the initial histogram includes a brightness cutoff threshold for the brightness level of the current frame;
calculate a normalized histogram for the current frame based on the brightness level of the current frame and a total number of pixels in the current frame;
select a set of pixel intensity values from a plurality of pixel intensity values for the current frame, wherein the set of pixel intensity values is within a threshold pixel intensity level of the brightness cutoff threshold, wherein the set of pixel intensity values is associated with a corresponding frequency of pixels;
estimate a set of parameters for a pixel intensity distribution of the current frame based on the set of pixel intensity values for the current frame, wherein the set of parameters is associated with a set of sample points corresponding to the set of pixel intensity values;
calculate an updated brightness cutoff threshold based on the set of pixel intensity values for the current frame and the estimated set of parameters for the pixel intensity distribution of the current frame;
map the updated brightness cutoff threshold to a backlight value of the current frame; and
transmit a second indication of the mapping of the updated brightness cutoff threshold to the backlight value of the current frame.

2. (canceled)

3. The apparatus of claim 1, wherein the at least one processor is further configured to:
transmit a third indication of the backlight value of the current frame based on the mapping of the updated brightness cutoff threshold to the backlight value of the current frame.

4. (canceled)

5. The apparatus of claim 1, wherein the at least one processor is further configured to:
calculate a normalized cumulative histogram for the current frame based on the normalized histogram.

6. The apparatus of claim 5, wherein to calculate the normalized cumulative histogram for the current frame, the at least one processor is configured to: sum a normalized frequency for each pixel intensity level of a set of pixel intensity levels in the normalized histogram.

7. The apparatus of claim 1, wherein to calculate the normalized histogram for the current frame, the at least one processor is configured to: divide a number of pixels per-brightness level of the current frame by the total number of pixels in the current frame.

8. The apparatus of claim 1, wherein the set of pixel intensity values is associated with a normalized cumulative distribution of the current frame.

9. The apparatus of claim 1, wherein to select the set of pixel intensity values, the at least one processor is configured to: filter the set of pixel intensity values within a range of the threshold pixel intensity level of the brightness cutoff threshold.

10. The apparatus of claim 9, wherein a size of the range of the threshold pixel intensity level is configurable based on a transition rate of a backlight level between the current frame and a subsequent frame in the set of frames.

11. The apparatus of claim 1, wherein the at least one processor is further configured to:
identify the brightness cutoff threshold of the initial histogram for the current frame based on the first indication of the initial histogram for the current frame.

12. The apparatus of claim 11, wherein the brightness cutoff threshold is configurable based on a pixel distortion level of the current frame.

13. The apparatus of claim 11, wherein the brightness level of the current frame is a gray level intensity, such that the brightness cutoff threshold is associated with the gray level intensity of the current frame.

14. The apparatus of claim 1, wherein the at least one processor is further configured to:
read data corresponding to the initial histogram for the current frame, wherein the data is associated with the brightness level of the current frame.

15. The apparatus of claim 14, wherein to read the data corresponding to the initial histogram for the current frame, the at least one processor is configured to: read the data corresponding to the initial histogram for the current frame from a histogram memory.

16. The apparatus of claim 1, wherein the initial histogram for the current frame is a brightness-level histogram for the current frame, and wherein the initial histogram for the current frame is associated with the display processing.

17. The apparatus of claim 1, wherein a model for the pixel intensity distribution of the current frame is an approximate Gaussian distribution model that is associated with an elimination of abrupt variations in pixel intensity frequencies for the current frame.

18. The apparatus of claim 1, further comprising a transceiver coupled to the at least one processor, wherein to obtain the first indication of the initial histogram for the current frame, the at least one processor is configured to: receive, via the transceiver, the first indication of the initial histogram for the current frame.

19. A method of display processing, comprising:
obtaining a first indication of an initial histogram for a current frame in a set of frames, wherein the initial histogram for the current frame is associated with a brightness level of the current frame, wherein the initial histogram includes a brightness cutoff threshold for the brightness level of the current frame;
calculating a normalized histogram for the current frame based on the brightness level of the current frame and a total number of pixels in the current frame;
selecting a set of pixel intensity values from a plurality of pixel intensity values for the current frame, wherein the set of pixel intensity values is within a threshold pixel intensity level of the brightness cutoff threshold, wherein the set of pixel intensity values is associated with a corresponding frequency of pixels;
estimating a set of parameters for a pixel intensity distribution of the current frame based on the set of pixel intensity values for the current frame, wherein the set of parameters is associated with a set of sample points corresponding to the set of pixel intensity values;
calculating an updated brightness cutoff threshold based on the set of pixel intensity values for the current frame and the estimated set of parameters for the pixel intensity distribution of the current frame;
mapping the updated brightness cutoff threshold to a backlight value of the current frame; and
transmitting a second indication of the mapping of the updated brightness cutoff threshold to the backlight value of the current frame.

20. The method of claim 19, further comprising:
transmitting a third indication of the backlight value of the current frame based on the mapping of the updated brightness cutoff threshold to the backlight value of the current frame.

21. (canceled)

22. The method of claim 19, further comprising:
calculating a normalized cumulative histogram for the current frame based on the normalized histogram, wherein calculating the normalized cumulative histogram for the current frame comprises: summing a normalized frequency for each pixel intensity level of a set of pixel intensity levels in the normalized histogram.

23. The method of claim 19, wherein calculating the normalized histogram for the current frame comprises: dividing a number of pixels per-brightness level of the current frame by the total number of pixels in the current frame.

24. The method of claim 19, wherein the set of pixel intensity values is associated with a normalized cumulative distribution of the current frame, wherein selecting the set of pixel intensity values comprises: filtering the set of pixel intensity values within a range of the threshold pixel intensity level of the brightness cutoff threshold, and wherein a size of the range of the threshold pixel intensity level is configurable based on a transition rate of a backlight level between the current frame and a subsequent frame in the set of frames.

25. The method of claim 19, further comprising:
identifying the brightness cutoff threshold of the initial histogram for the current frame based on the first indication of the initial histogram for the current frame, wherein the brightness cutoff threshold is configurable based on a pixel distortion level of the current frame, and wherein the brightness level of the current frame is a gray level intensity, such that the brightness cutoff threshold is associated with the gray level intensity of the current frame.

26. The method of claim 19, further comprising:
reading data corresponding to the initial histogram for the current frame, wherein the data is associated with the brightness level of the current frame, wherein reading the data corresponding to the initial histogram for the current frame comprises: reading the data corresponding to the initial histogram for the current frame from a histogram memory.

27. The method of claim 19, wherein the initial histogram for the current frame is a brightness-level histogram for the current frame, and wherein the initial histogram for the current frame is associated with the display processing.

28. The method of claim 19, wherein a model for the pixel intensity distribution of the current frame is an approximate Gaussian distribution model that is associated with an elimination of abrupt variations in pixel intensity frequencies for the current frame, and wherein obtaining the first indication of the initial histogram for the current frame comprises: receiving the first indication of the initial histogram for the current frame.

29. An apparatus for display processing, comprising:
means for obtaining a first indication of an initial histogram for a current frame in a set of frames, wherein the initial histogram for the current frame is associated with a brightness level of the current frame, wherein the initial histogram includes a brightness cutoff threshold for the brightness level of the current frame;
means for calculating a normalized histogram for the current frame based on the brightness level of the current frame and a total number of pixels in the current frame;
means for selecting a set of pixel intensity values from a plurality of pixel intensity values for the current frame, wherein the set of pixel intensity values is within a threshold pixel intensity level of the brightness cutoff threshold, wherein the set of pixel intensity values is associated with a corresponding frequency of pixels;
means for estimating a set of parameters for a pixel intensity distribution of the current frame based on the set of pixel intensity values for the current frame, wherein the set of parameters is associated with a set of sample points corresponding to the set of pixel intensity values;
means for calculating an updated brightness cutoff threshold based on the set of pixel intensity values for the current frame and the estimated set of parameters for the pixel intensity distribution of the current frame;
means for mapping the updated brightness cutoff threshold to a backlight value of the current frame; and
means for transmitting a second indication of the mapping of the updated brightness cutoff threshold to the backlight value of the current frame.

30. A non-transitory computer-readable medium storing computer executable code for display processing, the code when executed by a processor causes the processor to:
obtain a first indication of an initial histogram for a current frame in a set of frames, wherein the initial histogram for the current frame is associated with a brightness level of the current frame, wherein the initial histogram includes a brightness cutoff threshold for the brightness level of the current frame;
calculate a normalized histogram for the current frame based on the brightness level of the current frame and a total number of pixels in the current frame;
select a set of pixel intensity values from a plurality of pixel intensity values for the current frame, wherein the set of pixel intensity values is within a threshold pixel intensity level of the brightness cutoff threshold, wherein the set of pixel intensity values is associated with a corresponding frequency of pixels;
estimate a set of parameters for a pixel intensity distribution of the current frame based on the set of pixel intensity values for the current frame, wherein the set of parameters is associated with a set of sample points corresponding to the set of pixel intensity values;
calculate an updated brightness cutoff threshold based on the set of pixel intensity values for the current frame and the estimated set of parameters for the pixel intensity distribution of the current frame;
map the updated brightness cutoff threshold to a backlight value of the current frame; and
transmit a second indication of the mapping of the updated brightness cutoff threshold to the backlight value of the current frame.
